(19) United States
(12) Patent Application Publication
(10) Pub. No.: US 2024/0403771 A1
(43) Pub. Date: Dec. 5, 2024

(54) Ecosystem with Continuous Sustainability Model

(71) Applicant: Paresh B Fozdar, Elmhurst, NY (US)

(72) Inventor: Paresh B Fozdar, Elmhurst, NY (US)

(21) Appl. No.: 18/329,549

(22) Filed: Jun. 5, 2023

(51) Int. Cl. G06Q 10/0637

(52) U.S. Cl. CPC G06Q 10/0637

(57) ABSTRACT

The Ecosystem with Continuous Sustainability Model is generalized to work in any field to reduce greenhouse gases in the atmosphere: targets i.e. Air, Water and Land pollution to correct climate change, Environment harm correction by addressing root-cause at Social level and abide to Consumer-Centric business Purpose to kill excessive greed for profitability to stop Social harm. The model utilizes dual-approach to target disturbance in ecosystem: Restoration by existing resources to stop specie endangerment and Substitution identifies hazardous sources to adopt cost-effective alternative practice. The model corrects Ecosystem to sustain Human and Economic growth with Innovation

### APPROACH

To act on need to achieve Sustainable Human and Economic growth with Innovation

### COMPONENTS

Need
Disturbance Mitigation
Current Approach Analysis
Restoration Approach
Substitution Approach
Human Mentoring
Sustainability

### NEED

Climate Change
Greenhouse gas in atmosphere
Ecosystem must be self-contained to Live and Let Live

### DISTURBANCE MITIGATION

Mitigation occurs by stopping harm from Social to Environment level that creates pollution in air, water and land to generate disturbance in Ecosystem food-chain
Environment-level harm
   Forced vacation-shelter to encourage habitation of human in non-human nature to avail water and food
   Wind turbine installation in ocean to generate power
   Oil and gas drilling in ocean
Social-level harm
   Greed for profitability by manipulation using influence with non-ethical coercive wealth power
   Lost Purpose of business, government agency, philanthropy and non-profit

### CURRENT APPROACH ANALYSIS

Targets iterative-correction of past for visible-now and accountable for climate change by greenhouse gas and pollution
Loss (of past) looms larger than gain (of future) To Preach the dead
Where
   Past i.e. harm conducted to create pollution
   Preach the dead e.g. create-innovation to control or convert or transport or remove harmful gas
   Gain i.e. nature's ability to self-correct (by identification of harmful source and its correction)
      Initial Loss with concern to preach the dead
      i.e. prospect-theory with sunflower-effect by availability-bias for easy-innovation success to anchor to correct the past
      Forms
      Belief-Perseverance for correction
      To practice
      Disposition Effect with Representativeness
      i.e. identify pattern in correction of loss
      Forms
      Confirmation-bias with Free-Riding
      i.e. continue as direction matches most global-approach
      Allows
      Effect of Salience with framing
      i.e. ease to repurpose existing solution to acquire alike contract job by ill-minded

### RESTORATION APPROACH

Air and Satellite Surveillance to identify target density of harm on land and ocean

### Re-Utilization

Ocean plastic debris geography determination to extract or redirect waste to isolate
Employ existing solution to kill source not create new to complicate e.g. innovation for carbon and methane removal

### Endangerment

Save species approaching endangerment not extinction
Identify the weakness for target rescue specie to strengthen its liberation process

### EXAMPLES

Elephant weakness or mindset is its inability to break a rope hence identify dense topographic forest area to disallow rope
Whale weakness is social community bonding with collaboration in prey hunt as they are found in group while most suffer death by plastic mistaken for food hence identify prey density topography area in Ocean and Shore to avoid plastic discharge reach

### SUBSTITUTION APPROACH

Correction by substitution of environmental hazardous material for bio-degradable and non-harmful yet cost-effective
Plastic replacement by reusables and monitoring recycle-process
   E.g. government agency use plastic for waste collection in dense metropolitan
Corporation stops utilizing and manufacturing plastic for large consumables
   Food sale using plastic i.e. bag, can
   Fishery nets
   Synthetics
   Shopping bag
   Packaging
Healthcare and pharmaceuticals stringent regulation and monitoring with social-transparency
   E.g. need for clinical trial study on environment including: human, animals and plants
Consumer gain awareness to understand Environment, Social and Governance significance as:
   Stakeholder for employer
   Shareholder to invest
Entertainment restriction to visible nature and discourage exhibition of:
   Animals from forest
   Marine life from ocean
Human-Health by self-awareness and proactive evaluation
   Government and corporation use ethical and non-harmful detection, calibration and treatment-plan for human disease
   Human gain awareness to know body condition to identify and remedy root-problem

### HUMAN MENTORING

Coach and mentor government, businesses and human to stop environment and social misconception, misrepresentation, manipulation to restore Consumer-Centric Purpose
Misconception
   Genetic engineering to modify or create living specie to replicate the target extinct
   Natural food-chain broken by forced hierarchy and substitution
Misrepresentation
   Businesses and government agencies lack continuous monitoring for governance for its Environmental and Social responsibility in its Purpose
   Dense metropolitan with green to force greedy-green on concrete to convert planned to unplanned city
   Sanitation use purposeful ignorance for profitability to generate need for harmful chemical treatment
   Pet wildlife with intent to improvise
   Innovation to create illusive patch to reduce or prevent greenhouse gas in atmosphere
Manipulation
   Greed for ecstatic-euphoria
   To
   Breathe fictitiously-pure oxygen
   To
   Self-deceive for fake-wholesome food
   To
   Live beyond-fancy life
   Harms
   Ecosystem
   Leads-to
   Human-Extinction

### SUSTAINABILITY

Ripple-Effect of the Model for natural Sustainability
Pollution and greenhouse gas emissions reduced by correction-cycles for favorable climate
   Air e.g. low plastic recycling need hence no harmful gas discharge
   Water e.g. absence of plastic to stop harm to ocean to generate oxygen to air and water
   Land e.g. landfill waste used is bio-degradable to elevate green dense forest to generate oxygen to air
Endangerment to extinction possibility for specie is reduced
Live healthy eat well by naturally supportive food-chain for all organisms or species in Ecosystem
Nature flourishes to empower human for economic growth to reset-imagination for innovation to replace the artificial

1. The model is generalized to work in any field to reduce greenhouse gases in the atmosphere:
a. Targets: Air, Water and Land pollution to correct climate change
b. Environment harm correction by addressing root-cause at Social level
c. Abide to Consumer-Centric business Purpose to kill excessive greed for profitability to stop Social harm

2. The model utilizes dual-approach to target disturbance in ecosystem:
a. Restoration by existing resources to stop specie endangerment
b. Substitution identifies hazardous sources to adopt cost-effective alternative practice

3. The model corrects Ecosystem to sustain Human and Economic growth with Innovation
